(19) United States
(12) Patent Application Publication
(10) Pub. No.: US 2008/0270315 A1
(43) Pub. Date: Oct. 30, 2008

(54) MICROCURRENCY EXCHANGE SYSTEM

(75) Inventors: Chyr-Chong Ting, San Jose, CA (US); Adam Hyder, Los Altos, CA (US)

Correspondence Address: BEYER WEAVER LLP/Yahoo, P.O. BOX 70250, OAKLAND, CA, 94612-0250, US

(73) Assignee: YAHOO! INC., Sunnyvale, CA (US)

(21) Appl. No.: 11/742,432

(22) Filed: Apr. 30, 2007

(51) Int. Cl. G06Q 40/00

(52) U.S. Cl. 705/36 R

(57) ABSTRACT

A hosted microcurrency exchange management system includes a microcurrency exchange mechanism configured to coordinate interoperation of a plurality of microcurrency payment systems. Each microcurrency payment system is associated with one of a plurality of online commerce systems. The microcurrency exchange mechanism is configured to coordinate interoperation of the plurality of microcurrency payment systems includes coordinating exchange details, wherein the exchange details include exchange rate details among the microcurrencies. A management interface is configured to receive partnership formation information including the exchange details and to configure the exchange mechanism with the exchange details for completely formed partnerships.

### BACKGROUND

Micropayments are payments made in small scale, in which typical transaction costs would be high relative to the actual micropayment. Typically, credit cards require a minimum of $1 purchase and certain online stores that sell small items may choose to batch together multiple transactions into a single transaction. For online media, such as newspapers, it makes sense to charge a monthly subscription fee. However, users may only be interested in paying for specific articles. For example, it is thought that many users are only willing to pay up a maximum of $0.25 to read an article online. In certain scenarios, then, it may not make sense to use money as the actual currency but, rather, it may make more sense to use a less liquid currency that can only be exchanged within a closed economy. For example, airlines give frequent flyer miles that can be redeemed for air travel.

For a large online company such as Yahoo, there are various owned and operated businesses that can leverage a microcurrency economy. For example, currently, Yahoo Answers awards reward points to users for participation. This type of Yahoo currency has redemption value because Yahoo provides so much content and services. One example is that Yahoo Answers rewards points can be redeemed towards a subscription to Yahoo Music.

For many small businesses and online sites, however, it is difficult to build, operate, and maintain a microeconomy using an isolated microcurrency payment system. In particular, the business may desire more liquidity for its microcurrency to attract more customers and to increase the “value” of the microcurrency.

### SUMMARY

A hosted microcurrency exchange management system includes a microcurrency exchange mechanism configured to coordinate interoperation of a plurality of microcurrency payment systems. Each microcurrency payment system is associated with one of a plurality of online commerce systems. The microcurrency exchange mechanism is configured to coordinate interoperation of the plurality of microcurrency payment systems includes coordinating exchange details, wherein the exchange details include exchange rate details among the microcurrencies.

A management interface is configured to receive partnership formation information including the exchange details and to configure the exchange mechanism with the exchange details for completely formed partnerships.

### BRIEF DESCRIPTION OF THE DRAWINGS

FIG. 1 schematically illustrates an example infrastructure architecture of a microcurrency exchange system configured to coordinate interoperation of a plurality of microcurrency payment systems, including coordinating exchange details.

FIG. 2 is a flowchart illustrating an example of processing steps by the management interface of the FIG. 1 microcurrency exchange system.

FIG. 3 is a flowchart illustrating an example of processing steps of the exchange mechanism, configured to accomplish a partnership.

FIG. 4 schematically illustrates an example infrastructure architecture similar to that shown in FIG. 1, but in which the microcurrency accounts are centrally maintained by the exchange mechanism.

### DETAILED DESCRIPTION

The inventors have realized the desirability of providing an infrastructure system via which a plurality of microcurrency payment systems, each microcurrency payment system associated with one of a plurality of online commerce systems, can interoperate. In accordance with an aspect of the invention, such an infrastructure is provided, in which a microcurrency exchange mechanism is configured to coordinate interoperation of the plurality of microcurrency payment systems, including coordinating exchange details. The exchange details include exchange rate details among the microcurrencies. Furthermore, a management interface is provided via which partnership formation information may be provided.

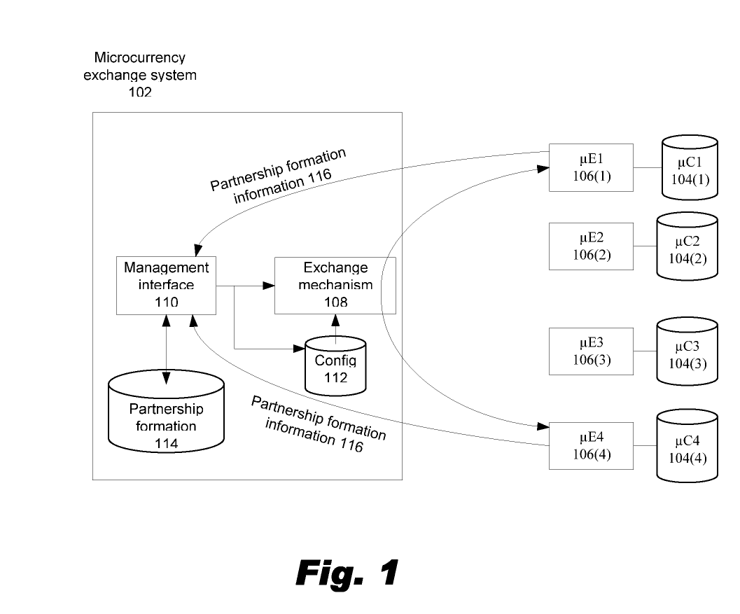

FIG. 1 schematically illustrates an example infrastructure architecture of such a microcurrency exchange system 102. For simplicity of illustration, FIG. 1 shows an environment in which there are four microeconomies μE1 106(1) to μE4 106(4) operating according to corresponding microcurrencies μC1 104(1) to μC4 104(4), respectively. In general, there may be many more such microeconomies. Each microeconomy (generically, 106) can operate as a closed system using its own microcurrency (generically, 104). That is, for a particular microeconomy, the corresponding microcurrency can be both earned and spent totally within that microeconomy. In some examples, a microeconomy be merely an economic unit, such as an online store, in which goods and/or services are sold for traditional currency (e.g., for dollars).

In addition, as illustrated in FIG. 1, the microcurrency exchange system 102 includes an exchange mechanism 108. The exchange mechanism is configured to coordinate interoperation of the plurality of microeconomies, includes coordinating exchange details. For example, the exchange details may include exchange rate details among the microcurrencies associated with the microeconomies. In the FIG. 1 illustration, the exchange mechanism is configured, according to a configuration 112, to coordinate interoperation of the microeconomy μE1 106(1) and the microeconomy μE4 106(4). Each microeconomy is generally in communication with the infrastructure system 102 via a network, such the internet.

As also shown in FIG. 1, the microcurrency exchange system 102 includes a management interface 110 to the exchange mechanism 108, and the management interface 110 operates at least in part in cooperation with partnership formation data 114. The partnership formation data 114 may include, in one example, a plurality of listings. Thus, for example, a listing may be provided for each participating microeconomy including at least the following items: 1) microcurrency; 2) product(s); and 3) service(s). Furthermore, each item of the listings has associated with it a monetary value in actual currency, including not only a monetary value associated with the microcurrency, but also a monetary value associated with the product(s) and/or service(s). While, in the example, the monetary value is expressed in US dollars, in other examples, the monetary value is expressed in some other country's currency, or even in a “made up” currency that provides a means to normalize the values of various microcurrencies, products and services.

An example of the listings of partnership formation data may include the following (“Partnership Formation Information” is discussed below.):

```
Microeconomy: Microsoft online site
1) XBOX Points ($0.01/point)
2) XBOX Game1 ($40)
    XBOX Game2 ($50)
Partnership Formation Information:  ,  ,  .
Microeconomy: Yahoo
1) Yahoo Answers Points ($0.001/point)
3) Yahoo Music ($20/yr)
    Yahoo Mail Premium ($10/yr)
Partnership Formation Information:  ,  ,  .
Microeconomy: American Airlines
1) Frequent Flyer Miles ($0.01/point)
2) Business Class Upgrade (domestic) ($150)
    Domestic Flight ($300)
Partnership Formation Information:  ,  ,  .
Microeconomy: Flowers.com
2) Dozen Roses ($12)
    Vase ($10)
Partnership Formation Information:  ,  ,  .
```

Furthermore, a microeconomy may use the partnership formation data 114 to indicate an interest in partnering with one or more other microeconomies. Generally, for an N-way partnership, each party must express interest in the other N-1 microeconomies by providing partnership formation information 116. For example, referring to the listings above, if the following:

Microsoft is interested in Yahoo and Flowers.com

Yahoo is interested in Microsoft and Flowers.com

Flowers.com is interested in Yahoo and Microsoft,

then the configuration 112 of the exchange mechanism 108 may be arranged such that the exchange mechanism 108 may coordinate interoperation of the Microsoft, Yahoo and Flowers.com microeconomies, including coordinating exchange details between the microeconomies. For example, a particular microeconomy may express interest in another microeconomy by indicating the other microeconomy in the “Partnership Formation Information” entry of the particular microeconomy.

Referring to the example microcurrency exchange system 102, the configuration 112 is such that the exchange mechanism 108 may coordinate interoperation of the plurality of the μE1 106(1) and μE4 106(4) microeconomies, includes coordinating exchange details. Thus, for example, the exchange mechanism coordinates interoperation of the Microsoft and American Airlines microeconomies such that a customer of the Microsoft microeconomy who wishes to purchase XBOX Game1 using American Airlines frequent flyer points is enabled to do so.

In on specific example, the following data structures may be employed for the partnership formation information 116 and the exchange mechanism configuration 112.

```
Partner
      partner_id
      partner_name
economy
      economy_id
      economy_name
Economy_partner
      economy_partner_id
      economy_id
      partner_id
product
      product_id
      partner_id
      product_name
      pegged_value
service
      service_id
      partner_id
      service_name
      pegged_value
currency
      currency_id
      partner_id
      currency_name
      currency_total_float
      pegged_value
economy_exchange
      economy_exchange_id
      economy_id
      economy_exchange_unit1_id (id of product, service, or currency)
      economy_exchange_unit2_id (id of product, service, or currency)
      conversion_rate
Partner_asset
      partner_asset_id
      partner_id
      economy_exchange_unit_id
      quantity
transaction
      transaction_id
      datetime
      economy_exchange_id
      quanity_unit1
      quanity_unit2
      transaction_value
```

Thus, for example, when a partner lists products & service & microcurrency the following tables may be populated:

partner

product

service

microcurrency

partner_asset

When N-partners form a microeconomy partnership, the following tables may be populated:

economy

economy_partner

economy_exchange (a conversion rate is set for an exchange)

When an exchange occurs, the following tables may be populated/modified

transaction

partner_asset

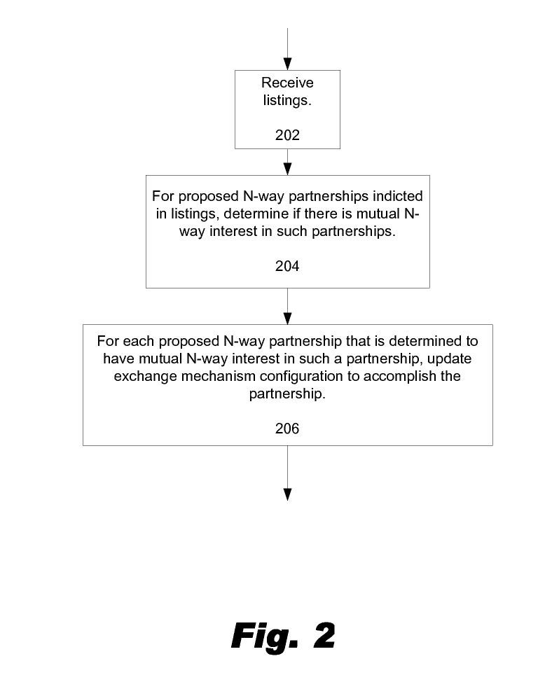

Turning to FIG. 2, we describe processing steps by the management interface 110. At step 202, the management interface 102 receives listings of partnership formation data, such as the listings just discussed. At step 204, for proposed N-way partnerships indicated in the listings, it is determined if there is mutual N-way interest in such partnerships. At step 206, for each proposed N-way partnership that is determined to have mutual N-way interest, the exchange mechanism configuration is arranged to accomplish the partnership.

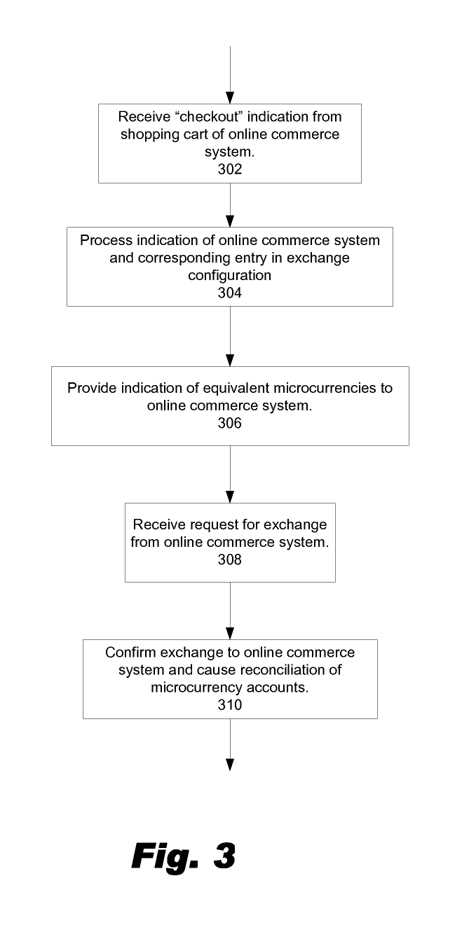

FIG. 3 is a flowchart that describes processing steps of the exchange mechanism, configured to accomplish a partnership. In particular, at step 302, the exchange mechanism receives a “checkout” indication from the shopping cart of an online commerce system (which is an example of a microeconomy). At step 304, the exchange mechanism processes the received indication from the online commerce system and a corresponding entry for the online commerce system in the exchange configuration. That is, the corresponding entry indicates, for example, details of the N-way partnerships for which the online commerce system microeconomy is a member and, for example, details of the exchange rate between the microcurrency of that microeconomy, if any, and microcurrencies of partner microeconomies.

At step 306, the exchange mechanism provides details of the N-way partnerships to the online commerce system that originated the “checkout” indication. At step 308, the exchange mechanism receives a request for exchange from the online commerce system that originated the “checkout” indication, e.g., based on interaction between a user and the online commerce system indicating a desire to make payment in the microcurrency of a partner microeconomy. At step 310, the exchange mechanism confirms the exchange to the online commerce system (e.g., after confirming that the user has an adequate balance of microcurrency of the partner microeconomy) and causes reconciliation of the microcurrency accounts.

While FIG. 3 illustrates that the exchange mechanism is accessed via an online shopping cart of a microeconomy, it should be noted that, in some examples, the access is via any interface that can access the exchange mechanism 108. For example, the exchange mechanism 108 may provide access via web services. In one example, a web page may be provided via which a user can access the exchange mechanism to “redeem” microcurrency (e.g., to redeem frequent flier miles). In another example, a user may access the exchange mechanism via a kiosk, such as provided in a casino, to redeem gambling awards.

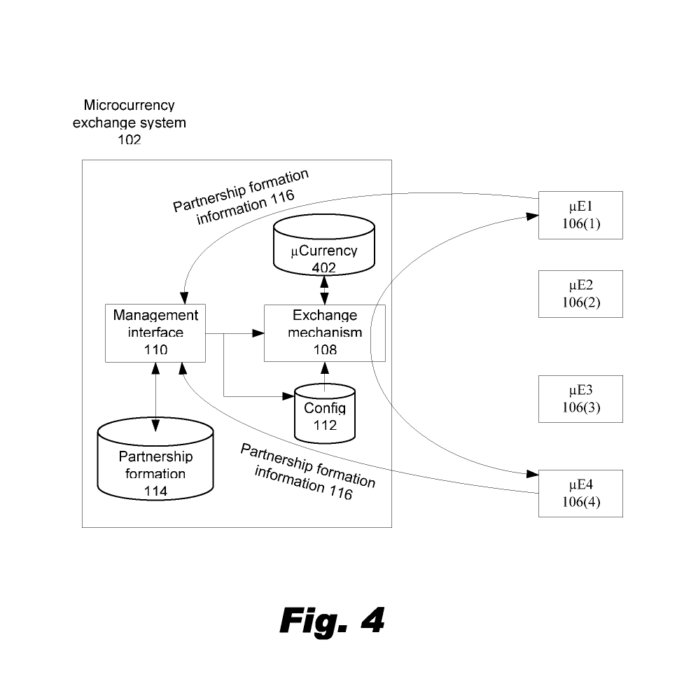

While FIG. 1 illustrates that each microeconomy maintains its own microcurrency accounts, in some examples, the microcurrency accounts may be centrally maintained by the exchange mechanism. FIG. 4 illustrates such an example. In particular, the microcurrency storage 402 represents the microcurrency accounts centrally maintained by the exchange mechanism. In yet other examples, some of the microcurrency accounts are maintained by the corresponding microeconomies, whereas others of the microcurrency accounts are centrally maintained.

We have described an infrastructure system via which a plurality of microcurrency payment systems, each microcurrency payment system associated with one of a plurality of online commerce systems, can interoperate. In accordance with an aspect of the invention, such an infrastructure is provided, in which a microcurrency exchange mechanism is configured to coordinate interoperation of the plurality of microcurrency payment systems, including coordinating exchange details. The exchange details include exchange rate details among the microcurrencies. Furthermore, a management interface is provided via which partnership formation information may be provided.

With the ability to easily form partnerships for microcurrency exchange among microeconomies, more liquidity is provided for the microcurrency, which may attract more customers by increasing the “value” of the microcurrency.

What is claimed is:

1. A hosted microcurrency exchange management system, comprising:
a microcurrency exchange mechanism configured to coordinate interoperation of a plurality of microcurrency payment systems, each microcurrency payment system associated with one of a plurality of online commerce systems, the microcurrency exchange mechanism being configured to coordinate interoperation of the plurality of microcurrency payment systems includes coordinating exchange details, wherein the exchange details include exchange rate details among the microcurrencies; and
a management interface configured to receive partnership formation information including the exchange details and to configure the exchange mechanism with the exchange details for completely formed partnerships.

2. The hosted microcurrency exchange management system of claim 1, wherein:
the exchange details include listings corresponding to online commerce systems, each listing comprising at least, for a particular online commerce system:
a proposed monetary value corresponding to the microcurrency associated with that online commerce system; and/or
a proposed monetary value for goods or services associated with that online commerce system.

3. The hosted microcurrency exchange management system of claim 1, wherein:
each listing further comprises an indication of interest relative to at least one other online commerce system.

4. The hosted microcurrency exchange management system of claim 3, wherein:
the management interface is configured to form partnerships based at least in part on indications of interest by ones of the online commerce systems in others of the online commerce systems by causing partnership formation information to be provided to configure the exchange mechanism.

5. The hosted microcurrency exchange system of claim 1, wherein:
the exchange mechanism hosts microcurrency for at least some of the plurality of microcurrency payment systems for which the exchange mechanism is configured to coordinate interoperation.

6. The hosted microcurrency exchange system of claim 1, wherein:
the exchange mechanism includes a web service via which the exchange mechanism is accessible to microeconomies for interoperation with other microeconomies.

7. A method of managing microcurrency exchange, comprising:
coordinating the interoperation of a plurality of microcurrency payment systems, each microcurrency payment system associated with one of a plurality of online commerce systems, including coordinating exchange details, wherein the exchange details include exchange rate details among the microcurrencies; and
receiving partnership formation information including the exchange details and configuring the exchange details for completely formed partnerships.

8. The microcurrency exchange managing method of claim 7, wherein:
the exchange details include listings corresponding to online commerce systems, each listing comprising at least, for a particular online commerce system:
a proposed monetary value corresponding to the microcurrency associated with that online commerce system; and/or
a proposed monetary value for goods or services associated with that online commerce system.

9. The microcurrency exchange managing method of claim 7, wherein:
each listing further comprises an indication of interest relative to at least one other online commerce system.

10. The microcurrency exchange managing method of claim 9, wherein:
configuring the exchange details for completely formed partnerships includes configuring the exchange details based at least in part on indications of interest by ones of the online commerce systems in others of the online commerce systems by causing partnership formation information to be provided to configure the exchange details.

11. The microcurrency exchange managing method of claim 7, further comprising:
hosting microcurrency for at least some of the plurality of microcurrency payment systems for which the exchange mechanism is configured to coordinate interoperation.
